(19) United States
(12) Patent Application Publication
(10) Pub. No.: US 2014/0123084 A1
(43) Pub. Date: May 1, 2014

(54) System and Method for Improving a Lithography Simulation Model

(71) Applicant: TAIWAN SEMICONDUCTOR MANUFACTURING COMPANY, LTD., (US)

(72) Inventors: Yu-Po Tang, Taipei City (TW); Chih-Shiang Chou, Pingzhen City (TW); Yan-Ting He, Taipei City (TW); Ya-Ting Chang, Nantou County (TW); Fu-Sheng Chu, Zhubei City (TW)

(73) Assignee: TAIWAN SEMICONDUCTOR MANUFACTURING COMPANY, LTD., Hsin-Chu (TW)

(21) Appl. No.: 13/666,270

(22) Filed: Nov. 1, 2012

(51) Int. Cl. G06F 17/50

(52) U.S. Cl. 716/53; 716/55; 716/55

(57) ABSTRACT

A method of performing initial optical proximity correction (OPC) with a calibrated lithography simulation model. The method includes providing a photomask having an integrated circuit (IC) pattern formed thereon, acquiring an aerial image of the IC pattern formed on the photomask using an optical microscope, and calibrating an optical component of the lithography simulation model based on the aerial image. The method also includes exposing and developing a photoresist layer on a semiconductor wafer using the photomask to form a post-development pattern on the photoresist layer, acquiring a post-development image of the post-development pattern on the photoresist layer, and calibrating the photoresist component of the lithography simulation model based on the post-development image. Further, the method includes performing initial optical proximity correction (OPC) on an IC design layout based on a simulation of the IC design layout by the lithography simulation model including the calibrated optical and photoresist components.

### BACKGROUND

The semiconductor integrated circuit (IC) industry has experienced rapid growth. In the course of IC evolution, functional density (i.e., the number of interconnected devices per chip area) has generally increased while geometry size (i.e., the smallest component (or line) that can be created using a fabrication process) has decreased. This scaling down process generally provides benefits by increasing production efficiency and lowering associated costs. Such scaling down has also increased the complexity of processing and manufacturing ICs and, for these advances to be realized, similar developments in IC manufacturing are needed. For example, as IC technologies are continually progressing to smaller technology nodes, such as 65 nm technology node, 45 nm technology node, and below, simply scaling down similar designs used at larger feature sizes often results in poorly shaped device features. As an example, rounded corners on a device feature that is designed to have right-angle corners may prevent the device from performing as desired. Typically, a lithography simulation model may be applied to a new design layout for an integrated circuit to simulate fabricating the integrated circuit with a lithography system. Errors identified by the simulated integrated circuit may be corrected by performing optical proximity correction (OPC) on the design layout before the pattern is formed on a photomask. However, when using known lithography simulation methods, it may be difficult to differentiate between errors in a simulated IC caused by optical effects and errors caused by chemical effects. Thus, traditional OPC modifications may not be effective to eliminate all errors in a fabricated integrated circuit because of less than desirable lithography simulation models. Accordingly, although existing approaches have been satisfactory for their intended purposes, they have not been entirely satisfactory in all respects.

### BRIEF DESCRIPTION OF THE DRAWINGS

The present disclosure is best understood from the following detailed description when read with the accompanying figures. It is emphasized that, in accordance with the standard practice in the industry, various features are not drawn to scale and are used for illustration purposes only. In fact, the dimensions of the various features may be arbitrarily increased or reduced for clarity of discussion.

FIG. 1 is a simplified block diagram of an embodiment of an integrated circuit (IC) manufacturing system and an associated IC manufacturing flow.

FIG. 2 is a high-level flowchart of a method for performing optical proximity correction (OPC) using a calibrated lithography simulation model associated with a lithography process.

FIG. 3 illustrates a simplified block diagram of aspects of the integrated circuit (IC) manufacturing system of FIG. 1 including a lithography simulation model.

FIG. 4 illustrates an example optical microscope system that may be utilized to generate an aerial image.

### DETAILED DESCRIPTION

It is understood that the following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

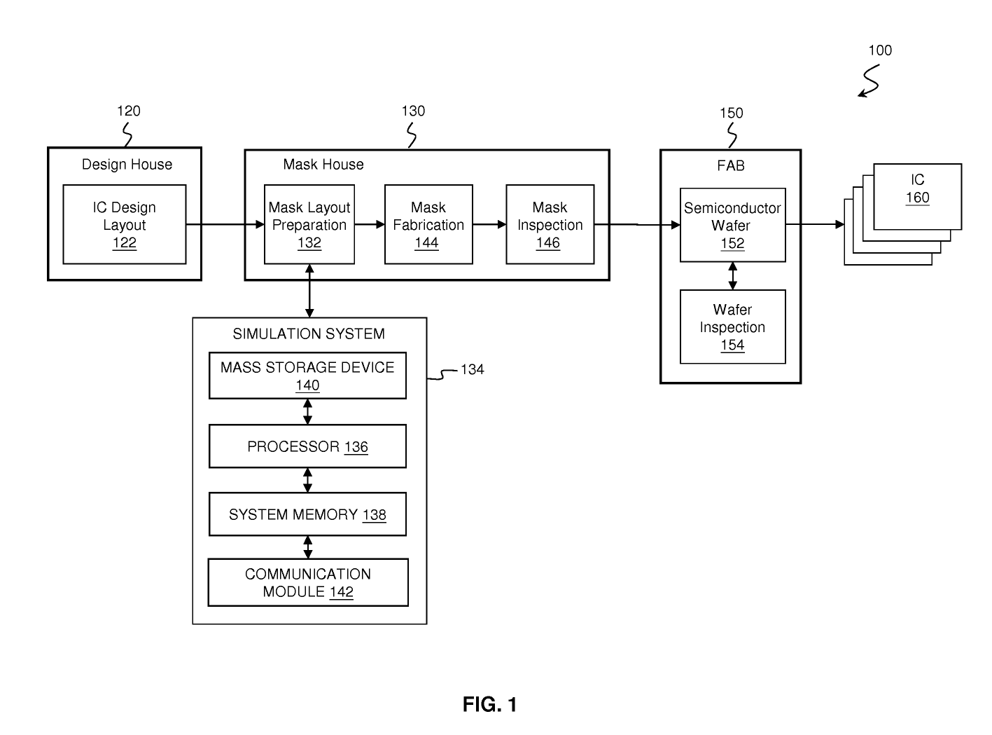

FIG. 1 is a simplified block diagram of an embodiment of an integrated circuit (IC) manufacturing system 100 and an IC manufacturing flow associated with the IC manufacturing system. The IC manufacturing system 100 includes a plurality of entities, such as a design house 120, a mask house 130, and an IC manufacturer 150 (i.e., a fab), that interact with one another in the design, development, and manufacturing cycles and/or services related to manufacturing an integrated circuit (IC) device 160. The plurality of entities are connected by a communications network, which may be a single network or a variety of different networks, such as an intranet and the Internet, and may include wired and/or wireless communication channels. Each entity may interact with other entities and may provide services to and/or receive services from the other entities. The design house 120, mask house 130, and IC manufacturer 150 may be a single entity or separate entities, and may be housed in a single facility or may be geographically remote from each other.

The design house (or design team) 120 generates an IC design layout 122. The IC design layout 122 includes various geometrical patterns designed for an IC product, based on a specification of the IC product to be manufactured. The geometrical patterns correspond to patterns of metal, oxide, or semiconductor layers that make up the various components of the IC device 160 to be fabricated. The various layers combine to form various IC features. For example, a portion of the IC design layout 122 includes various IC features, such as an active region, gate electrode, source and drain, metal lines or vias of an interlayer interconnection, and openings for bonding pads, to be formed in a semiconductor substrate (such as a silicon wafer) and various material layers disposed on the semiconductor substrate. The design house 120 implements a proper design procedure to form the IC design layout 122. The design procedure may include logic design, physical design, and/or place and route. The IC design layout 122 is presented in one or more data files having information of the geometrical patterns. For example, the IC design layout 122 can be expressed in a GDSII file format (or DFII file format). The mask house 130 uses the IC design layout 122 to manufacture one or more masks to be used for fabricating the various layers of the IC product according to the IC design layout 122. The mask house 130 performs mask layout preparation 132, where the IC design layout 122 is translated into a form that can be physically written by a mask writer.

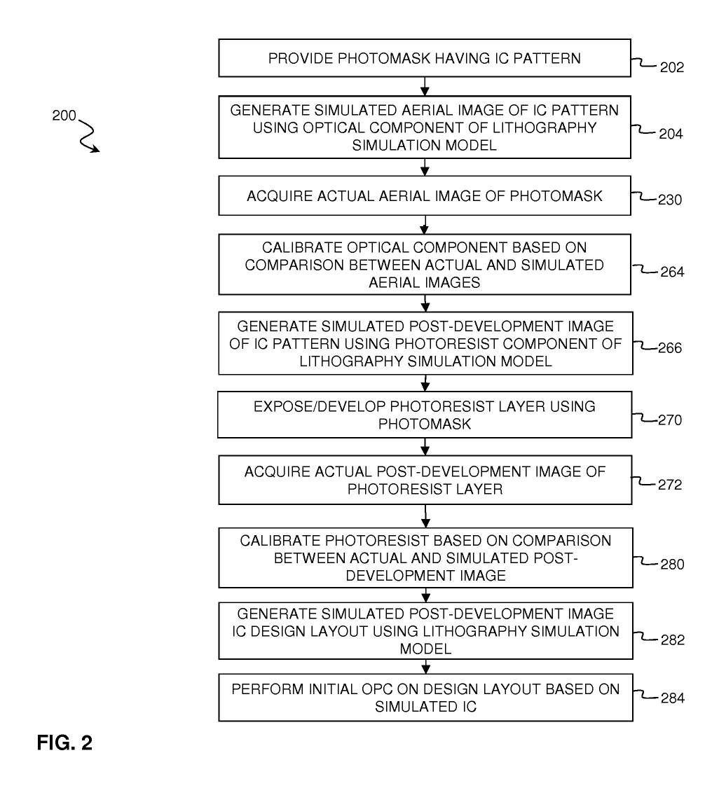

Commonly, mask layout preparation 132 includes optical proximity correction (OPC) and a lithography process check (LPC) 140. OPC is a lithography enhancement technique used to compensate for image errors, such as those that can arise from diffraction, interference, or other process effects. The OPC process may add features, such as scattering bars, serif, and/or hammerheads to the IC design layout 122 according to optical models or rules such that, after a lithography process, a final pattern on a wafer is improved with enhanced resolution and precision. In order to determine what errors will appear in a fabricated integrated circuit based on the design layout, the lithography fabrication process is simulated by providing the design layout to a lithography simulation model. The lithography simulation model generates a simulated integrated circuit that includes the formation errors that would exist if the design layout was fabricated into an integrated circuit without change. OPC modifications may be made to the design layout 122 based on the errors exhibited by the simulated integrated circuit. Simulating a design layout prior to performing OPC will be discussed in greater detail in association with FIGS. 2-4. The mask data preparation 132 can include further resolution enhancement techniques, such as off-axis illumination, sub-resolution assist features, phase-shifting masks, other suitable techniques, or combinations thereof.

As shown in the illustrated embodiment of FIG. 1, the mask house 130 may include a simulation system 134 that is operable to perform the lithography simulation tasks discussed above. Specifically, in one embodiment, the simulation system 134 is an information handling system such as a computer, server, workstation, handheld computing device, or other suitable computing device or collection of communicatively coupled computing devices. The system 134 includes a processor 136 that is communicatively coupled to a system memory 138, a mass storage device 140, and a communication module 142. The system memory 138 provides the processor 136 with non-transitory, computer-readable storage to facilitate execution of computer instructions by the processor. Examples of system memory may include random access memory (RAM) devices such as dynamic RAM (DRAM), synchronous DRAM (SDRAM), solid state memory devices, and/or a variety of other memory devices known in the art. Computer programs, instructions, and data are stored on the mass storage device 140. Examples of mass storage devices may include hard discs, optical disks, magneto-optical discs, solid-state storage devices, and/or a variety other mass storage devices known in the art. The communication module 142 is operable to receive data such as IC design layout data from local and remote networked systems and communicate information such as finalized mask design data to the other components in the mask house 130. Examples of communication modules may include Ethernet cards, 802.11 WiFi devices, cellular data radios, and/or other suitable devices known in the art.

During mask fabrication 144, a mask or group of masks are fabricated based on the mask design layout which incorporates one or more copies of the IC design layout 122 as modified by mask layout preparation 132. For example, an electron-beam (e-beam) or a mechanism of multiple e-beams is used to form a pattern on a mask (photomask or reticle) based on the mask design layout. The mask can be formed in various technologies. In one embodiment, the mask is formed using binary technology. In the present embodiment, a mask pattern includes opaque regions and transparent regions. A radiation beam, such as an ultraviolet (UV) beam, used to expose the image sensitive material layer (e.g., photoresist) coated on a wafer, is blocked by the opaque region and transmits through the transparent regions. In one example, a binary mask includes a transparent substrate (e.g., fused quartz) and an opaque material (e.g., chromium) coated in the opaque regions of the mask. In another example, the mask is formed using a phase shift technology. In the phase shift mask (PSM), various features in the pattern formed on the mask are configured to have proper phase difference to enhance the resolution and imaging quality. In various examples, the phase shift mask can be attenuated PSM or alternating PSM as known in the art.

After a mask has been fabricated, the mask house performs a mask inspection 146 to determine if the fabricated mask includes any defects, such as full-height and non-full-height defects. If any defects are detected, the mask may be cleaned or the mask design layout and/or IC design may be modified further depending on the types of defects detected.

It should be understood that the above description of the mask layout preparation 132 has been simplified for the purposes of clarity, and layout preparation may include additional features such as a logic operation (LOP) to modify the IC design layout according to manufacturing rules, a retarget process (RET) to modify the IC design layout to compensate for limitations in lithographic processes used by IC manufacturer 150, and a mask rule check (MRC) to modify the IC design layout to compensate for limitations during mask fabrication 144. Additionally, the processes applied to the IC design layout 122 during mask fabrication 144 and mask inspection 146 may be executed in a variety of different orders and may include a variety of different and/or additional steps.

The IC manufacturer 150, such as a semiconductor foundry, uses the mask (or masks) fabricated by the mask house 130 to fabricate a semiconductor wafer 152 having a plurality of the IC devices 160 thereon. The IC manufacturer 150 is an IC fabrication business that can include a myriad of manufacturing facilities for the fabrication of a variety of different IC products. For example, there may be a manufacturing facility for the front end fabrication of a plurality of IC products (i.e., front-end-of-line (FEOL) fabrication), while a second manufacturing facility may provide the back end fabrication for the interconnection and packaging of the IC products (i.e., back-end-of-line (BEOL) fabrication), and a third manufacturing facility may provide other services for the foundry business. In the present embodiment, the semiconductor wafer 152 is fabricated using the mask (or masks) to form a plurality of the IC devices 160. The semiconductor wafer includes a silicon substrate or other proper substrate having material layers formed thereon. Other proper substrate materials include another suitable elementary semiconductor, such as diamond or germanium; a suitable compound semiconductor, such as silicon carbide, indium arsenide, or indium phosphide; or a suitable alloy semiconductor, such as silicon germanium carbide, gallium arsenic phosphide, or gallium indium phosphide. The semiconductor wafer may further include various doped regions, dielectric features, and multilevel interconnects (formed at subsequent manufacturing steps). The mask may be used in a variety of processes. For example, the mask may be used in an ion implantation process to form various doped regions in the semiconductor wafer, in an etching process to form various etching regions in the semiconductor wafer, in a deposition process (e.g., chemical vapor deposition (CVD) or physical vapor deposition (PVD)) to form a thin film in various regions on the semiconductor wafer, and/or other suitable processes.

After a semiconductor wafer 152 has been fabricated it may be subjected to wafer testing 154 to ensure the integrated circuits formed thereon conform to physical manufacturing specifications and electrical performance specifications. Commonly, test structures (or process control monitors) formed on the wafer during lithography may be utilized to generate test data indicative of the quality of the fabricated semiconductor wafer. After the wafer 152 passes wafer testing 154, it may be diced (or sliced) along scribe lines to separate the IC devices 160 formed thereon. The dicing process can be accomplished by scribing and breaking, by mechanical sawing (e.g., with a dicing saw) or by laser cutting. Following the dicing process, the plurality of IC devises 160 are individually packaged for use in building electronic devices and, in some embodiments, may be subjected to further individual testing.

FIG. 2 is a high-level flowchart of a method 200 for performing OPC using a calibrated lithography simulation model associated with a lithography process. In the illustrated embodiment, the method 200 is carried out by portions of the integrated circuit (IC) manufacturing system 100 including the simulation system 134 shown in FIG. 1. Further, in one embodiment, portions of the method 200 may be implemented as computer-readable instructions stored on the mass storage device 140 or system memory 138 and executed by the processor 136 of the simulation system 134. In general, the method 200 updates (or calibrates) a lithography simulation model that identifies potential fabrication errors in an IC design layout so that the layout may be modified by OPC. Further, the method 200 in FIG. 1 is a high-level overview and details associated with certain blocks in the method will be described in association with subsequent figures in the present disclosure.

The method 200 of performing OPC using a calibrated lithography simulation model begins at block 202 where a photomask (or reticle) having an IC pattern thereon is provided. The IC pattern may represent one or more layers of a design layout of an integrated circuit, and, in one embodiment, may be a test pattern known to have no errors or only identified errors. A photomask with a test pattern known to have no errors may be useful in tracking the “drift” of lithography equipment and chemicals over time. In other embodiments, the IC pattern may be a design layout for a production integrated circuit on which OPC modifications have yet to be made. Specifically, in certain embodiments, the IC pattern may be the design layout that will be subjected to OPC modifications in a subsequent block of method 200.

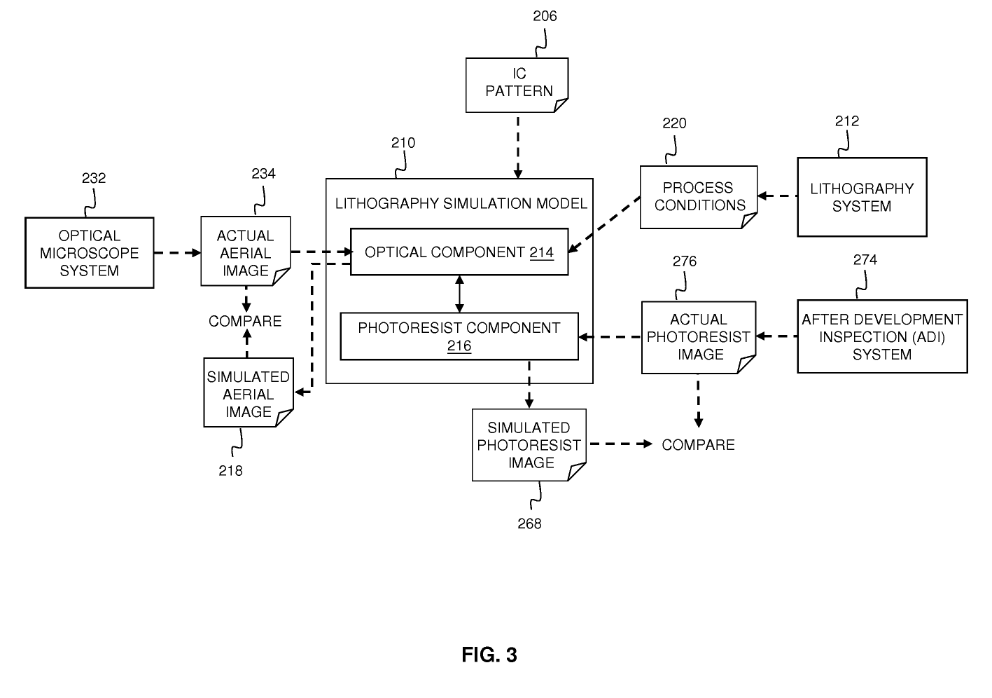

The method 200 next proceeds to block 204 where a simulated aerial image of the IC pattern of block 202 is generated by applying an optical component of a lithography simulation model to the IC pattern. In more detail, FIG. 3 illustrates a simplified block diagram of aspects of the integrated circuit (IC) manufacturing system 100 of FIG. 1 including an IC pattern 206 and a lithography simulation model 210. The IC pattern 206 is a digital representation (e.g., GDSII, etc) of the IC pattern on the photomask provided in block 202. Additionally, in certain embodiments, the lithography simulation model 210 may be implemented as computer-readable instructions stored on the mass storage device 140 or system memory 138 and executed by the processor 136 of the simulation system 134. In other embodiments, the lithography simulation model 210 may be implemented in hardware, or as a hardware-software hybrid. The lithography simulation model 210 is operable to simulate the fabrication of an IC design layout onto a semiconductor wafer by a lithography processes. The lithography simulation model 210 is operable to simulate wafer fabrication by a scanner or stepper, such as a lithography system 212, and associated photoresist processing. As will be discussed below, an accurate simulation of the lithography process used to form an IC pattern on a wafer may be utilized to determine the manner in which the IC pattern should be modified during OPC without having to actually fabricate a wafer using the IC pattern. In the illustrated embodiment of FIG. 3, the lithography simulation model 210 includes an optical component 214 and a photoresist component 216. In general, the optical component 214 models the illumination, lens, and mask aspects of the lithography system 212, while the photoresist component 216 models the photoresist aspects of fabrication, such as baking and development.

In more detail, the optical component 214 is configured to simulate the generation and passage of light through a patterned photomask and onto a wafer below. Specifically, in one embodiment, the optical component is configured to generate a simulated aerial image 218 of the IC pattern 206 that illustrates how light passing through a photomask having the IC pattern will appear when incident upon a wafer. To accurately model the optical aspects of the lithography system 212, the optical component 214 of the lithography simulation model 210 may receive as input process conditions 220 associated with the lithography system 212 that describe the specific characteristics of the lithography system. For example, the process conditions 220 may include variables describing lithography aspects such as light source shape, light wavelength, light intensity, light field of scanner illumination, transfer function of the scanner pupil, the light field through the mask, polarization decomposition, and other aspects associated with photolithography optics systems. Further, the process conditions 220 may include variables describing photomask aspects such as photomask layer properties and other photomask optical aspects. U.S. patent application Ser. No. 13/409,515, entitled “METHODS OF EMULATING AERIAL IMAGES”, discloses modeling of lithography optical systems in more detail and is hereby incorporated by reference in its entirety.

With reference back to FIG. 2, after the optical component 214 generates a simulated aerial image 218 of the IC pattern 206 in block 204, the method 200 continues to block 230 where an actual aerial image generated by the IC pattern formed on the photomask is acquired. In more detail, and referring back to FIG. 3, an optical microscope system 232 is utilized to shine light onto the IC pattern 206 formed on the photomask and capture an aerial image of the pattern of light passing therethrough. In one embodiment, the optical microscope system 232 generates an actual aerial image 234 of the IC pattern 206 by replicating the illumination and optical features of the lithography system 212. As will be describe below, in an optical microscope system, the semiconductor wafer is replaced with a camera that captures the pattern of light passing through the photomask.

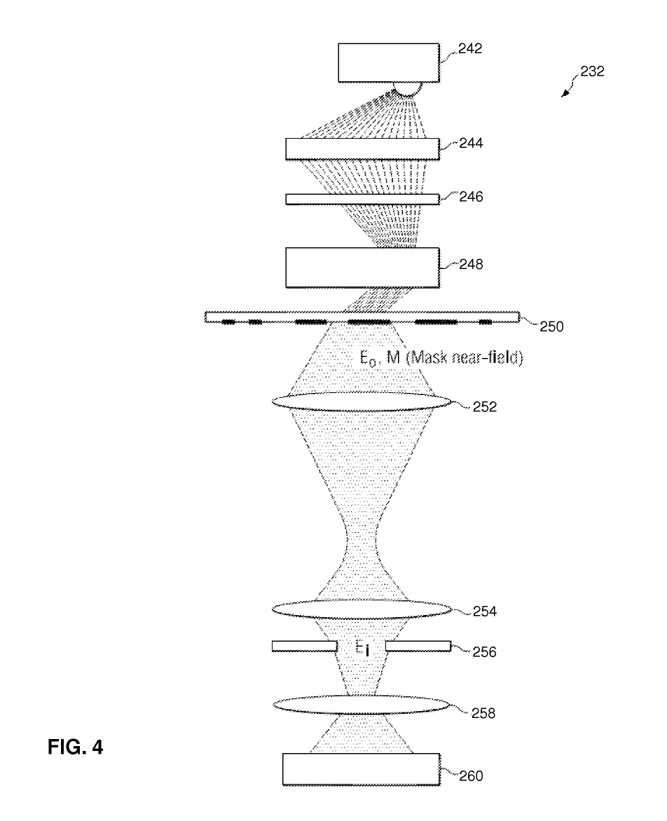

In that regard, FIG. 4 illustrates the example optical microscope system 232 that may be utilized to generate the actual aerial image 234. Optical microscope system 232 includes a light source 242. Light source 242 may include any suitable light source known in the art. In addition, light source 242 may be selected to simulate the light that a photomask would be illuminated with during a lithography process. For example, light source 242 may be configured to generate light having substantially similar characteristics (e.g., wavelength, polarization, intensity, etc.) of an lithography system that will be utilized in actual wafer fabrication. In some instances, the light source 242 may be the same light source that is part of the production lithography system. Light generated by light source 242 passes through tube lens 244, polarizer 246, and condenser lens 248. Light exiting condenser lens 248 illuminates photomask (or reticle) 250. Tube lens 244, polarizer 246, and condenser lens 248 may be selected such that the light that illuminates photomask 250 has substantially similar characteristics as light that would illuminate photomask 250 in a stepper or scanner exposure tool during production. Optical microscope system 232 also includes objective lens 252 that is configured to collect light transmitted through photomask 250. Light passes through post magnifying optics 254, NA turntable 256, Bertrand optics 258, and finally to a camera 260. In one embodiment, the camera 260 is a CCD-camera and is configured to detect the light exiting Bertrand optics 258 that is in the pattern of the light transmitted by photomask 250. As mentioned above, to most accurately recreate the production lithography system, some or all of the components in the optical microscope system 232 may be the same components as used in the production lithography system 212 of FIG. 3. In other embodiments, the components may different but tuned to substantially mimic the components in the production system. Further, the optical microscope system 232 may include additional and/or different component such as lens and projection systems in alternative embodiments.

Referring back to FIG. 2, after the optical microscope system 232 generates an actual aerial image 234 in block 230, the method proceeds to block 264. There, the optical component 214 of the lithography simulation model 210 is calibrated using the actual aerial image 234. In more detail, in one embodiment, the actual aerial image 234 produced by the optical microscope system 232 is compared to the simulated aerial image 218 from the optical component 214. Any differences extracted by the comparison may be utilized to calibrate the optical component 214 of the lithography simulation model 210 so that it may produce more accurate simulated aerial images that replicate the IC pattern 206 as it would be projected onto a wafer in the lithography system 212. In certain embodiments, calibration of the optical component 214 may include altering variables describing optical lithography aspects such as light source shape, light wavelength, light intensity, light field of scanner illumination, transfer function of the scanner pupil, the light field through the mask, polarization decomposition, and other variables associated with photolithography optics systems. Further, the variables related to photomask aspects such as photomask layer properties may be altered during the calibration of the optical component 214. In other embodiments, the actual aerial image 234 may be utilized to calibrate the optical component 214 in various other manners such as by working backwards from the light pattern captured in the actual aerial image to extrapolate the photomask pattern from which the light pattern was created. The extrapolated photomask pattern may then be compared to the original IC pattern 206 or utilized in other ways.

After the optical component 214 is calibrated in block 264, the method 200 continues to block 266, where the photoresist component 216 of the lithography simulation model 210 is applied to the IC pattern 206 to generate a simulated post-development image 268. In more detail, the photoresist component 216 is operable to simulate an image of a pattern formed in a layer of photoresist after development if the photoresist layer had been exposed using a photomask having the IC pattern 206 formed thereon. In other words, the photoresist component 216 takes the simulated aerial image generated by the result of the optical component 214 and further simulates the exposure of a photoresist layer and development. Notably, by separately modeling the optical aspects of a lithography process and the photoresist-related aspects of the lithography process, the source of wafer fabrication errors may be more easily identified (i.e., optical defects vs. chemical defects). To accurately model the photoresist aspects of a lithography process, the photoresist component 216 of the lithography simulation model 210 may receive as input photoresist conditions associated with the photoresist process that will be used during actual wafer production. For example, photoresist process conditions may include variables describing aspects related to photoresist layer chemical composition, photoresist layer thickness, post-exposure baking time/temperature/pressure, development time, development chemical compositions, and other variables related to photoresist exposure, baking, and development.

After the photoresist component 216 of the lithography simulation model 210 produces a simulated post-development image 268 of the IC pattern 206, the method 200 continues to block 270. There, an actual photoresist layer on a wafer is exposed and developed using the lithography system 212 and the photomask having the IC pattern 206 therein. The post-development photoresist pattern is formed by a lithography process known in the art. For example, in one embodiment, the lithography process includes photoresist coating (e.g., spin-on coating), soft baking, mask aligning, exposure, post-exposure baking, developing the photoresist, rinsing, drying (e.g., hard baking), other suitable processes, and/or combinations thereof.

The method 200 then continues to block 272 where an actual post-development image of the post-development photoresist pattern is captured. Referring back to FIG. 3, an after-development inspection (ADI) system 274 is operable to acquire an actual post-development image 276 of the patterned photoresist layer. In one embodiment, the ADI system 274 may be a scanning electron microscope (SEM), but, in other embodiments, it may be another type of imaging system such as an optical inspection tool, an electron-beam (e-beam) inspection tool, a scanning probe microscope system, a laser microscope system, a transmission electron microscope system, a focus ion beam microscope system, or another suitable imaging system.

Next, the method 200 proceeds to block 280 where the photoresist component 216 of the lithography simulation model 210 is calibrated using the actual post-development image 276. In more detail, in one embodiment, the actual post-development image 276 produced by the ADI system 274 is compared to the simulated post-development image 268 from the photoresist component 216. Any differences extracted by the comparison may be utilized to calibrate the photoresist component 216 of the lithography simulation model 210 so that it may produce more accurate simulated post-development images of a patterned photoresist layer that replicate the IC pattern 206 as it would be formed on a wafer by the lithography system 212 and subsequent photoresist processing. In certain embodiments, calibration of the photoresist component 216 may include altering variables representing photoresist layer chemical composition, photoresist layer thickness, post-exposure baking time/temperature/pressure, development time, development chemical compositions, and other conditions related to photoresist exposure, baking, and development. Additionally, in one embodiment, the optical component 214 of the lithography simulation module may be further calibrated based on the actual post-development photoresist image because both optical and photoresist aspects of the lithography system 212 influence the final pattern formed on a wafer.

Thus, after the optical component 214 and photoresist component 216 have been calibrated in blocks 264 and 280, the lithography simulation model 210 is improved such that it may better simulate wafer fabrication by the lithography system 212 and associated photoresist processing. In other words, after calibration, a simulated post-development image produced by feeding a production IC design layout to the lithography simulation model 210 may be substantially similar to a post-development pattern formed in a photoresist layer using the lithography system 212 and a photomask having the production IC design layout formed thereon. A well-calibrated lithography simulation model may be used to more effectively perform OPC on the production IC design layout.

In that regard, after the optical component 214 and photoresist component 216 have been calibrated, the method 200 optionally continues to block 282 where the calibrated lithography simulation model 210 is utilized to generate a simulated post-development image based on a production IC design layout. In one embodiment, the production IC design layout is different than the IC pattern 206 utilized to calibrate the lithography simulation model 210 (i.e., when the IC pattern 206 is an error-free test pattern). In other embodiments, the production IC design layout is the same as the IC pattern 206.

Finally, after the simulated post-development image based on the production IC design layout has been created in block 282, the method 200 ends at block 284 where initial OPC modifications are performed on the production IC design layout based on the simulated post-development image. For instance, OPC features may be added to the production IC design layout to compensate for distorting effects of diffraction and scattering, hotspots, pinching, corner rounding, and other unwanted aspects that are identified in the simulated post-development image. Notably, prior to block 284, the IC design layout may be free of OPC modifications.

It is understood that the method 200 of performing OPC using a calibrated lithography simulation model is simply an example embodiment, and in alternative embodiments, additional and/or different steps may be included in the method. Further, steps may be excluded from the method 200 in certain embodiments. For example, after block 284, the OPC-modified production IC design layout may be simulated again using the lithography simulation model 210 to determine the effectiveness of the OPC features. Further, after block 284, a photomask may be fabricated with OPC-modified production IC design layout, and utilized with the lithography system 212 to fabricate IC devices on semiconductor wafers.

Further, portions of the method 200 of performing OPC using a calibrated lithography simulation model in the illustrated embodiments are designed to be executed on any computing architecture, such as the systems described in association with the IC manufacturing system 100 of FIGS. 1 and 3. For example, portions of the method 200 may be executed on a single computer, local area networks, client-server networks, wide area networks, internets, hand-held and other portable and wireless devices and networks. Such architecture can take the form of an entirely hardware embodiment, an entirely software embodiment, or an embodiment containing both hardware and software elements. Hardware generally includes at least processor-capable platforms, such as client-machines (also known as personal computers or servers), and hand-held processing devices (such as smart phones, personal digital assistants (PDAs), or personal computing devices (PCDs), for example. Hardware can include any physical device that is capable of storing machine-readable instructions, such as memory or other data storage devices. Other forms of hardware include hardware sub-systems, including transfer devices such as modems, modem cards, ports, and port cards, for example. Software generally includes any machine code stored in any memory medium, such as RAM or ROM, and machine code stored on other devices (such as floppy disks, flash memory, or a CD-ROM, for example). Software can include source or object code, for example. In addition, software encompasses any set of instructions capable of being executed in a client machine or server.

Furthermore, embodiments of the present disclosure can take the form of a computer program product accessible from a tangible computer-usable or computer-readable medium providing program code for use by or in connection with a computer or any instruction execution system. For the purposes of this description, a tangible computer-usable or computer-readable medium can be any apparatus that can contain, store, communicate, propagate, or transport the program for use by or in connection with the instruction execution system, apparatus, or device. The medium can be an electronic, magnetic, optical, electromagnetic, infrared, a semiconductor system (or apparatus or device), or a propagation medium.

Data structures are defined organizations of data that may enable an embodiment of the present disclosure. For example, a data structure may provide an organization of data, or an organization of executable code. Data signals could be carried across transmission mediums and store and transport various data structures, and, thus, may be used to transport an embodiment of the present disclosure.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

In one exemplary aspect, the present disclosure is directed to a method of performing initial optical proximity correction (OPC) with a calibrated lithography simulation model. The method includes providing a photomask having an integrated circuit (IC) pattern formed thereon, acquiring an aerial image of the IC pattern formed on the photomask using an optical microscope, and calibrating an optical component of the lithography simulation model based on the aerial image. The method also includes exposing and developing a photoresist layer on a semiconductor wafer using the photomask to form a post-development pattern on the photoresist layer, acquiring a post-development image of the post-development pattern on the photoresist layer, and calibrating the photoresist component of the lithography simulation model based on the post-development image. Further, the method includes performing initial optical proximity correction (OPC) on an IC design layout based on a simulation of the IC design layout by the lithography simulation model including the calibrated optical and photoresist components.

In another exemplary aspect, the present disclosure is directed to a method of calibrating a lithography simulation model. The method includes providing a photomask having an integrated circuit (IC) pattern formed thereon, generating a simulated aerial image of the IC pattern by applying an optical component of a lithography simulation model to the IC pattern, and acquiring an actual aerial image of the IC pattern formed on the photomask using an optical microscope. The method also includes calibrating the optical component of the lithography simulation model based on a comparison between the simulated aerial image and the actual aerial image, generating a simulated post-development image by applying a photoresist component of the lithography simulation model to the IC pattern, and exposing and developing a photoresist layer on a semiconductor wafer using the photomask to form a post-development pattern on the photoresist layer. Additionally, the method includes acquiring an actual post-development image of the post-development pattern on the photoresist layer and calibrating the photoresist component of the lithography simulation model based on a comparison between the simulated post-development image and the actual post-development image.

In yet another exemplary aspect, the present disclosure is directed to a system for performing initial optical proximity correction (OPC) with a calibrated lithography simulation model. The system includes an optical microscope configured to capture an aerial image of an integrated circuit (IC) pattern formed on a photomask, a lithography system configured to expose and develop a photoresist layer on a semiconductor wafer with the photomask to form a post-development pattern on the photoresist layer, and an imaging system to capture a post-development image of the post-development pattern on the photoresist layer. The system also includes a lithography simulation model including an optical component and a photoresist component and configured to simulate fabrication of the IC pattern onto the semiconductor wafer by the lithography system, a processor, and a non-transitory, computer-readable storage communicatively coupled to the processor and including instructions executable by the processor. The instructions include instructions to calibrate an optical component of the lithography simulation model based on the aerial image, instructions to calibrate the photoresist component of the lithography simulation model based on the post-development image, and instructions to perform initial optical proximity correction (OPC) on an IC design layout based on a simulation of the IC design layout by the lithography simulation model including the calibrated optical and photoresist components.

1. A method of performing initial optical proximity correction (OPC) with a calibrated lithography simulation model, comprising:
providing a photomask having a production integrated circuit (IC) pattern formed thereon, wherein the production IC pattern is a production design layout for a production integrated circuit on which OPC modifications have yet to be made;
acquiring an aerial image of the production IC pattern formed on the photomask using an optical microscope;
calibrating an optical component of the lithography simulation model based on the aerial image;
exposing and developing a photoresist layer on a semiconductor wafer using the photomask to form a post-development pattern on the photoresist layer;
acquiring a post-development image of the post-development pattern on the photoresist layer;
calibrating a photoresist component of the lithography simulation model based on the post-development image;
further calibrating the optical component of the lithography simulation model based on the post-development image; and
performing initial optical proximity correction (OPC) modifications on the production design layout based on a simulation of the production design layout by the lithography simulation model including the calibrated optical and photoresist components.

2. A method according to claim 1, wherein calibrating the optical component based on the aerial image includes:
generating a simulated aerial image of the production IC pattern by applying the optical component of the lithography simulation model to the production IC pattern; and
comparing the simulated aerial image to the acquired aerial image to extract differences therebetween.

3. A method according to claim 1, wherein calibrating the optical component includes adjusting one or more of a plurality of process parameters associated with optical aspects of a lithography system.

4. A method according to claim 3, wherein the plurality of process parameters may include one or more of light source shape, light wavelength, light intensity, light field of scanner illumination, transfer function of a scanner pupil, and polarization decomposition.

5. A method according to claim 1, wherein calibrating the photoresist component includes:
generating a simulated post-development image by applying the photoresist component of the lithography simulation model to the production IC pattern; and
comparing the simulated post-development image to the acquired post-development image to extract differences therebetween.

6. A method according to claim 1, wherein calibrating the photoresist component includes adjusting one or more of a plurality of processing parameters associated with aspects of a photoresist development process

7. A method according to claim 6, wherein the plurality of processing parameters include one or more of photoresist layer chemical composition, photoresist layer thickness, post-exposure baking time/temperature/pressure, development time, development chemical compositions, and other variables related to photoresist exposure, baking, and development.

8. A method according to claim 1, wherein the optical microscope includes a camera that is configured to capture a pattern of light passing through the photomask.

9. A method according to claim 1, wherein acquiring the post-development image is performed with a scanning electron microscope (SEM).

10. (canceled)

11. A method of calibrating a lithography simulation model, comprising:
providing a photomask having a production integrated circuit (IC) pattern formed thereon, wherein the production IC pattern is a production design layout for a production integrated circuit on which OPC modifications have yet to be made;
generating a simulated aerial image of the production IC pattern by applying an optical component of a lithography simulation model to the production IC pattern;
acquiring an actual aerial image of the production IC pattern formed on the photomask using an optical microscope;
calibrating the optical component of the lithography simulation model based on a comparison between the simulated aerial image and the actual aerial image;
generating a simulated post-development image by applying a photoresist component of the lithography simulation model to the production IC pattern;
exposing and developing a photoresist layer on a semiconductor wafer using the photomask to form a post-development pattern on the photoresist layer;
acquiring an actual post-development image of the post-development pattern on the photoresist layer;
calibrating the photoresist component of the lithography simulation model based on a comparison between the simulated post-development image and the actual post-development image;
further calibrating the optical component of the lithography simulation model based on the actual post-development image; and
performing initial optical proximity correction (OPC) modifications on the production design layout based on a simulation of the production design layout by the lithography simulation model including the calibrated optical and photoresist components.

12. (canceled)

13. (canceled)

14. A method according to claim 11, wherein calibrating the optical component includes adjusting one or more of a plurality of process parameters associated with optical aspects of a lithography system.

15. A method according to claim 14, wherein the plurality of process parameters may include one or more of light source shape, light wavelength, light intensity, light field of scanner illumination, transfer function of a scanner pupil, and polarization decomposition.

16. A method according to claim 11, wherein calibrating the photoresist component includes adjusting one or more of a plurality of processing parameters associated with aspects of a photoresist development process.

17. A method according to claim 16, wherein the plurality of processing parameters include one or more of photoresist layer chemical composition, photoresist layer thickness, post-exposure baking time/temperature/pressure, development time, development chemical compositions, and other variables related to photoresist exposure, baking, and development.

18. A system for performing initial optical proximity correction (OPC) with a calibrated lithography simulation model, comprising:
an optical microscope configured to capture an aerial image of a production integrated circuit (IC) pattern formed on a photomask, wherein the production IC pattern is a production design layout for a production integrated circuit on which OPC modifications have yet to be made;
a lithography system configured to expose and develop a photoresist layer on a semiconductor wafer with the photomask to form a post-development pattern on the photoresist layer;
an imaging system to capture a post-development image of the post-development pattern on the photoresist layer;
a lithography simulation model including an optical component and a photoresist component and configured to simulate fabrication of the production IC pattern onto the semiconductor wafer by the lithography system;
a processor; and
a non-transitory, computer-readable storage communicatively coupled to the processor and including instructions executable by the processor, the instructions including:
instructions to calibrate an optical component of the lithography simulation model based on the aerial image;
instructions to calibrate the photoresist component of the lithography simulation model based on the post-development image;
instructions to further calibrate the optical component of the lithography simulation model based on the post-development image; and
instructions to perform initial optical proximity correction (OPC) modifications on the production design layout based on a simulation of the production design layout by the lithography simulation model including the calibrated optical and photoresist components.

19. A system according to claim 18, wherein the instructions to calibrate the optical component based on the aerial image include:
instructions to generate a simulated aerial image of the production IC pattern by applying the optical component of the lithography simulation model to the production IC pattern; and
instructions to compare the simulated aerial image to the captured aerial image to extract differences therebetween.

20. A system according to claim 18, wherein instructions to calibrate the photoresist component include:
instructions to generate a simulated post-development image by applying the photoresist component of the lithography simulation model to the production IC pattern; and
instructions to compare the simulated post-development image to the captured post-development image to extract differences therebetween.
